(19) United States
(12) Patent Application Publication
(10) Pub. No.: US 2026/0177014 A1
(43) Pub. Date: Jun. 25, 2026

(54) ENGINE IGNITION FLAG SYSTEM

(71) Applicant: Oshkosh Corporation, Oshkosh, WI (US)

(72) Inventor: Korry Kobel, Oshkosh, WI (US)

(73) Assignee: Oshkosh Corporation, Oshkosh, WI (US)

(21) Appl. No.: 19/427,543

(22) Filed: Dec. 19, 2025

Related U.S. Application Data
(60) Provisional application No. 63/737,026, filed on Dec. 20, 2024.

(51) Int. Cl. F02D 41/22; F02D 41/00; F02N 11/08

(52) U.S. Cl. CPC F02D 41/22; F02D 41/0097; F02N 11/0862; F02N 2200/022

(57) ABSTRACT

An engine ignition flag system may include an engine, a starter motor coupled to turn the engine, a battery configured to power the starter motor, a sensor coupled to the engine and configured to provide sensor data indicating a speed of the engine, a user interface and a controller operatively coupled to the sensor. The controller is configured to receive, from the sensor, the sensor data corresponding to a measurement period, determine, based the speed of the engine during the measurement period, a condition of the battery, and, control the user interface to provide a notification indicating the condition of the battery.

### CROSS-REFERENCE TO RELATED PATENT APPLICATION

This application claims the benefit of and priority to U.S. Provisional Application No. 63/737,026, filed on Dec. 20, 2024, the entire disclosure of which is hereby incorporated by reference herein.

### BACKGROUND

The present disclosure relates generally to work machines. More specifically, the present disclosure relates to an engine ignition system for work machines. Work machines include lift assemblies, vehicles, and other machinery with engines. An ignition system for a work machine may include a starter motor that is used to start an engine. Starting the engine may require a healthy battery to supply electrical energy to the starter motor for powering the engine until the engine is self-sustaining.

### SUMMARY

At least one embodiment relates to an engine ignition flag system including an engine, a starter motor coupled to turn the engine, a battery configured to power the starter motor, a sensor coupled to the engine and configured to provide sensor data indicating a speed of the engine, a user interface and a controller operatively coupled to the sensor. The controller is configured to receive, from the sensor, the sensor data corresponding to a measurement period, determine, based the speed of the engine during the measurement period, a condition of the battery, and, control the user interface to provide a notification indicating the condition of the battery.

Another embodiment relates to a method of determining a battery condition. The method may include controlling a battery to operate a starter motor to start an engine, measuring, using a sensor, an engine property of the engine while the starter motor is operated, and determining, based on the engine property, a condition of the battery.

Another embodiment relates to a method of displaying a battery condition. The method includes powering, by a battery, a starter motor to turn an engine, measuring, with a sensor, an engine speed of the engine for a measurement period, determining whether the engine speed reached a threshold speed during the measurement period, and providing a notification to a display indicating the battery condition.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic representation of an engine ignition flag system including a work machine, according to an exemplary embodiment.

FIG. 2 is a front perspective view of the work machine of FIG. 1 configured as a telehandler, according to an exemplary embodiment.

FIG. 3 is a flow chart of a method for operating the engine ignition flag system of FIG. 1, according to an exemplary embodiment.

FIG. 4 is a flow chart of a method for operating the engine ignition flag system of FIG. 1, according to an exemplary embodiment.

FIG. 5 is a graph of engine speeds of the work machine of FIG. 1 during ignition, according to various exemplary embodiments.

FIG. 6 is a graph of engine speeds of the work machine of FIG. 1 associated with failing battery conditions, according to various exemplary embodiments.

### DETAILED DESCRIPTION

Before turning to the figures, which illustrate certain some embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, various exemplary embodiments disclosed herein relate to systems and methods for an engine ignition flag system. For example, a system is configured to measure speeds of an engine during ignition and to send a notification to a display device to display whether the battery is failing based on the measured engine speeds. The display device can be located on a work machine, on the jobsite of the work machine, or off the jobsite. Additionally, the display may include a display screen, a lamp or light, an audio device, a dial, or another display or output device. The notification may include textual, auditory, visual, or other sensory indications or cues. The engine ignition system assists machine operators in monitoring the condition of the battery by notifying machine operators when a battery is healthy enough to power the turning of the engine to an idle speed and when the health of the battery has deteriorated and requires replacement. Additionally, the determination of battery condition may require calculations, assessments, or other determinations involving the measurements of engine speeds. In some embodiments, the engine ignition system measures an engine property of an engine by sensing the engine or engine components. A processing circuit within the system may generate an engine characteristic based on the measured engine property. The engine characteristic may include estimated parameters, calculated parameters, and qualitative assessments. The sensors for measuring an engine property may be configured to measure speed, position, power, and other factors. The engine ignition flag system may be deployed in a work machine or other engine-based machinery.

The figures also refer generally to the various exemplary embodiments disclosed herein relate to systems, apparatuses, and methods for an engine ignition flag system. In some embodiments, the engine ignition flag system can include work machines, control modules, work site equipment, communication interfaces, and display devices. The information provided to the engine ignition flag system can be communicated to a machine operator through a user interface. In some embodiments, the user interface shows a work machine location, a jobsite location, and a battery condition. In some embodiments, the user interface includes a color-coded warning indicator, an audible alarm, or another indicator structured to communicate to the machine operator that the battery condition requires the attention of the operator.

### Engine Ignition System

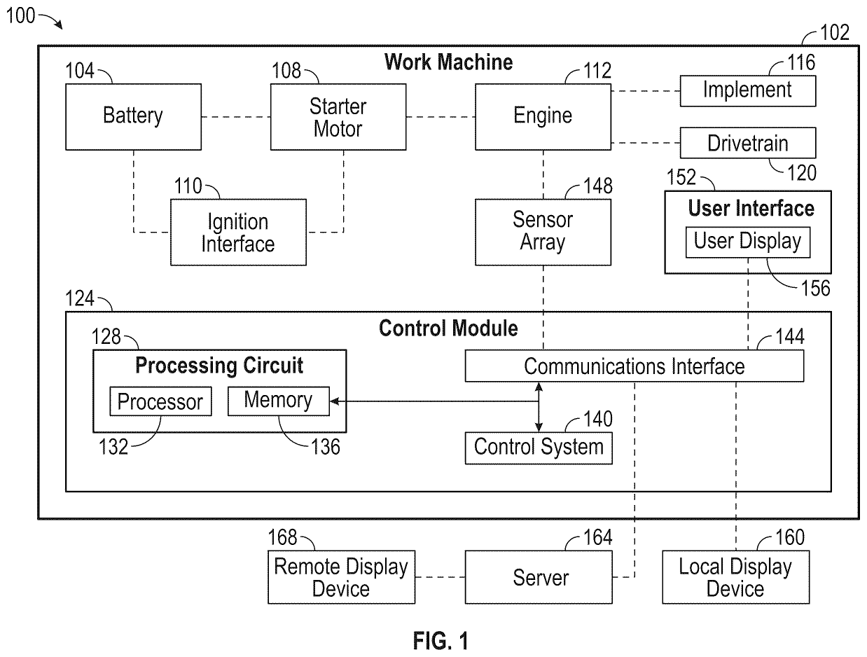

FIG. 1 shows a schematic representation of an engine ignition flag system 100 including a work machine 102, according to some embodiments. The work machine 102 (e.g., a telehandler, a boom lift, a scissor lift, a refuse vehicle, a concrete mixing truck, a military vehicle, a passenger vehicle, etc.) includes a prime mover, shown as engine 112, (e.g., a spark ignition engine, a compression ignition engine, an electric motor, a generator set, a hybrid system, etc.) structured to supply power (e.g., rotational mechanical energy, electrical energy, etc.) to the work machine 102, and an implement 116, and a drivetrain 120 driven by the engine 112. In some embodiments, the implement 116 includes a lift boom, a scissor lift, a telehandler arm, etc.

To activate or start the engine 112, the work machine 102 includes a battery 104 structured to supply power (e.g., electrical energy) to a starter motor 108 (e.g., gear-reduction, direct-drive, solenoid-operated, etc.) that is configured to turn, start, or activate the engine 112, and an ignition interface 110 (e.g., key, button, mobile application, biometric authorization, etc.) coupled to the starter motor 108 and configured to activate the battery 104 and the starter motor 108.

As the components of FIG. 1 are shown to be embodied in the work machine 102, a controller or processing circuitry, shown as control module 124, may be structured as one or more electronic control units (ECU). The control module 124 may be separate from or included with at least one of an implement control unit, an exhaust after-treatment control unit, a powertrain control module, an engine control module, etc. In some embodiments, the control module 124 includes a processing circuit 128 having a processor 132 and a memory device, shown as memory 136, a control system 140, and a communications interface 144. Generally, the control module 124 is structured to receive inputs from a sensor array 148 (e.g., one or more sensors) and generate outputs (e.g., an electronic notification, a machine-to-machine communication, an engine ignition flag system, a user interface, a network, etc.) through the communications interface 144.

The control system 140 generates a range of inputs, outputs, and user interfaces. The inputs, outputs, and user interfaces may be related to a jobsite, a status of a piece of equipment, environmental conditions, equipment telematics, an equipment location, task instructions, sensor data, equipment consumables data (e.g. a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

The sensor array 148 can include physical and virtual sensors for determining the states, conditions, positions, and other measurable qualities of the work machine 102 or work machine components. In some embodiments, the sensor array includes a position sensor, a timing sensor, speed sensor, or other sensors structured to determine a position of the work machine 102 or work machine components relative to locations, maps, other equipment, objects, or other reference points. In some embodiments, the sensor array 148 senses an engine component (e.g., crankshaft, camshaft, cylinders, etc.) to measure an engine property (e.g., engine speed, torque, etc.).

In one configuration, the control system 140 is embodied as machine or computer-readable media that is executable by a processor, such as the processor 132. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the control system 140 is embodied as hardware units, such as electronic control units. As such, the control system 140 may be embodied as one or more circuitry components including, but not limited to, processing circuitry, network interfaces, peripheral devices, input devices, output devices, sensors, etc. In some embodiments, the control system 140 may take the form of one or more analog circuits, electronic circuits (e.g., integrated circuits (IC), discrete circuits, system on a chip (SoC) circuits, microcontrollers, etc.), telecommunication circuits, hybrid circuits, and any other type of “circuit.” In this regard, the control system 140 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 140 may also include programmable hardware devices such as field programmable gate arrays, programmable array logic, programmable logic devices or the like. The control system 140 may include one or more memory devices for storing instructions that are executable by the processor(s) of the control system 140. The one or more memory devices and processor(s) may have the same definition as provided below with respect to the memory 136 and the processor 132. In some hardware unit configurations, the control system 140 may be geographically dispersed throughout separate locations in the machine. Alternatively, and as shown, the control system 140 may be embodied in or within a single unit/housing, which is shown as the control module 124.

In the example shown, the control module 124 includes a processing circuit 128 having the processor 132 and the memory 136. The processing circuit 128 may be structured or configured to execute or implement the instructions, commands, and/or control processes described herein with respect to control system 140 (e.g., the processing circuit 128 may be part of the control system 140). The depicted configuration represents the control system 140 as machine or computer-readable media. However, as mentioned above, this illustration is not meant to be limiting as the present disclosure contemplates other embodiments where the control system 140, or at least one circuit of the control system 140, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 132) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any other processor or state machine. A processor also may be implemented as a combination of computing devices, such as a combination of a DSP and a microprocessor, a series of microprocessors, one or more microprocessors in conjunction with a DSP core, or any other such configuration. In some embodiments, the one or more processors may be shared by multiple circuits (e.g., control system 140 may comprise or otherwise share the same processor which, in some example embodiments, may execute instructions stored, or otherwise accessed, in different areas of memory). Alternatively or additionally, the one or more processors may be structured to perform or otherwise execute certain operations independent of one or more co-processors. In other example embodiments, two or more processors may be coupled by a bus to enable independent, parallel, pipelined, or multi-threaded instruction execution. All such variations are intended to fall within the scope of the present disclosure.

The memory 136 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 136 may be communicably connected to the processor 132 to provide computer code or instructions to the processor 132 for executing at least some of the processes described herein. Moreover, the memory 136 may be or include tangible, non-transient volatile memory or non-volatile memory. Accordingly, the memory 136 may include database components, object code components, script components, or any other type of information structure for supporting the various activities and information structures described herein.

In an exemplary embodiment, the memory 136 stores instructions for execution by the processor 132 for a process to automatically generate and send a notification based on a condition of the battery 104. The process to automatically generate and send a notification automatically measures the speed of the engine 112, determines the condition of the battery 104, and selects devices to send the notification to. In some embodiments, the process automatically calculates the acceleration of the engine 112 and determines whether the engine speed has reached an idle speed. In some embodiments, the automatic process is based on a rule stored on a work machine or on another network node. In some embodiments, the rule is based on one or more of a work site designation, a location of a machine, or a code (e.g., a customer key, a manufacturer key, or a maintainer key).

The communications interface 144 is arranged in communication with the sensor array 148 to monitor the condition of the battery 104. The communications interface 144 permits a machine operator to interact with a user interface 152 and receive a notification of the condition of the battery 104 through an output device, shown as user display 156, for communicating to the machine operator. By way of example, the output device may include a display screen, a lamp or light, an audio device, a dial, or another display or output device. The user interface 152 may also include an input device. The user interface 152 may be configured to provide information to and receive information (e.g., commands) from a machine operator (e.g., through the user display 156). By way of example, the user interface 152, may include screens, buttons, switches, joysticks, or other types of interface devices. The user interface 152 may be disposed within the cabin 208. Additionally or alternatively, the user interface 152 may be included as part of a user device (e.g., a smartphone, a table, a laptop computer, a desktop computer, etc.).

In some embodiments, the communications interface 144 is arranged in communication with a local display device 160 or a remote display device 168 through a server 164 to facilitate a machine operator receiving a notification of the condition of the battery 104. The local display device 160 and the remote display device 168 may be a display screen, a lamp or light, an audio device, a dial, or another display or output device. In some embodiments, the local display device 160 may be a user device located on the jobsite and connected locally (e.g., Wi-Fi, Bluetooth, USB, etc.). In some embodiments, the remote display device 168 may be a user device located off the jobsite and connected remotely through the server 164 (e.g., Wi-Fi, Bluetooth, USB, etc.).

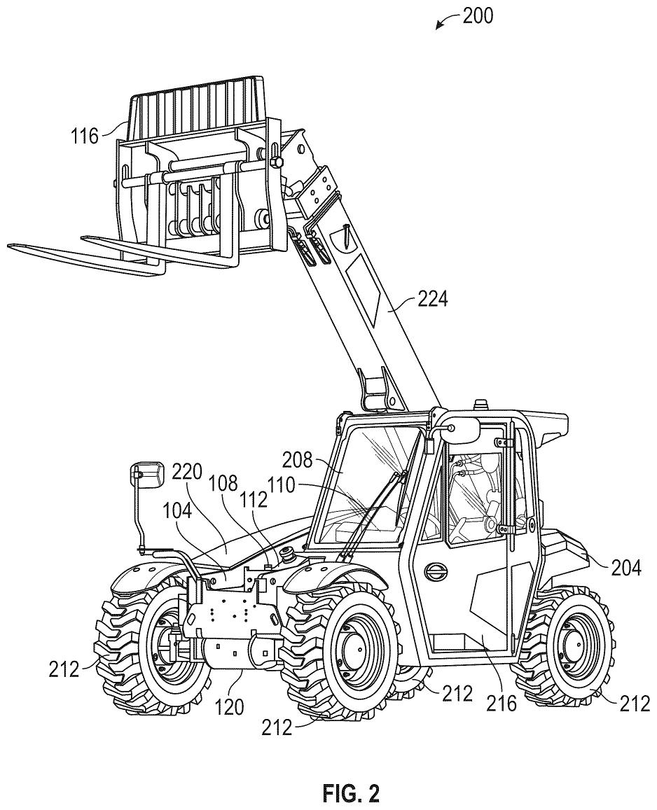

FIG. 2 shows a front perspective view of the work machine 102 of FIG. 1 configured as a telehandler 200 according to an exemplary embodiment. In other embodiments, the work machine 102 is configured as a boom lift, an aerial work platform, a scissor lift, a vertical lift, a compact crawler boom, a forklift, a crane, a bucket truck, or another type of lift device. In yet other embodiments, the work machine 102 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, or another type of vehicle or work machine.

As shown in FIG. 2, the telehandler 200 includes a chassis, shown as frame assembly 204. The frame assembly 204 supports an enclosure, shown as cabin 208, that is configured to house a machine operator of the telehandler 200. The telehandler 200 is supported by a series of tractive elements 212 (e.g., wheel and tire assemblies) that are rotatably coupled to the frame assembly 204. As shown, the tractive elements 212 include a pair of front wheels (e.g., supported on a front axle) positioned proximate a front end of the frame assembly 204 and a pair of rear wheels (e.g., supported on a rear axle) positioned proximate a rear end of the frame assembly 204. One or more of the tractive elements 212 may be powered by the drivetrain 120 (e.g., driven by the engine 112) to facilitate motion of (e.g., propel) the telehandler 200.

The cabin 208 includes a door 216 configured to facilitate selective access into the cabin 208. The door 216 may be located on the lateral side of the cabin 208 opposite a boom assembly 224. An enclosure, shown as housing 220, is coupled to the frame assembly 204. The housing 220 may contain various components of the telehandler 200 (e.g., the engine 112, the pump, a fuel tank, a hydraulic fluid reservoir, etc.). The housing 220 may include one or more doors to facilitate access to components of the telehandler 200.

Each of the tractive elements 212 may be powered or unpowered. Referring to FIG. 2, the telehandler 200 includes the engine 112. The engine 112 may receive fuel (e.g., gasoline, diesel, natural gas, etc.) from a fuel tank and combust the fuel to generate mechanical energy. According to an exemplary embodiment, the engine 112 is a compression-ignition internal combustion engine that utilizes diesel fuel. In alternative embodiments, the engine 112 is another type of device (e.g., spark-ignition engine, fuel cell, etc.) that is otherwise powered (e.g., with gasoline, compressed natural gas, hydrogen, etc.).

As shown in FIG. 2, a pump receives the mechanical energy from the engine 112 and provides pressurized hydraulic fluid to power the tractive elements 212 and the other hydraulic components of the telehandler 200 (e.g., an outrigger actuators, a lift actuator, an extension actuator, an implement actuator, etc.). The pump may provide a pressurized flow of hydraulic fluid to individual motive drivers (e.g., hydraulic motors) configured to facilitate independently driving each of the tractive elements 212 (e.g., in a hydrostatic transmission configuration). In such embodiments, the telehandler 200 also includes other components to facilitate use of a hydraulic system (e.g., reservoirs, accumulators, hydraulic lines, valves, flow control components, etc.). In other embodiments, the engine 112 provides mechanical energy to the tractive elements 212 through another type of transmission. By way of example, a drive shaft may transfer rotational mechanical energy from the engine 112 to the tractive elements 212. In yet other embodiments, the telehandler 200 includes an energy storage device (e.g., a battery, capacitors, ultra-capacitors, etc.) and/or is electrically coupled to an outside source of electrical energy (e.g., a standard power outlet coupled to the power grid). In some such embodiments, one or more of the tractive elements 212 include an individual motive driver (e.g., an electric motor that is electrically coupled to the energy storage device, etc.) configured to facilitate independently driving each of tractive elements 212. The outside source of electrical energy may charge the energy storage device or power the motive drivers directly. In such embodiments, the engine 112 may drive a generator to provide electrical energy that is used to power the motive drivers.

The telehandler 200 includes a lift assembly, shown as the boom assembly 224, having a proximal end that is pivotably coupled to the rear end of the frame assembly 204. A distal end of the boom assembly 224 supports a tool or manipulator, shown as the implement 116. The implement 116 may be any type of mechanism used to support, grab, or otherwise interact with the payload. The implement 116 may include one or more of a carriage and/or set of forks (e.g., pallet forks, bale forks, etc.), a bucket, a grapple or grab (e.g., a bale grab, a log grab, a shear grab, a grab for use in combination with a bucket, etc.), a boom (e.g., a boom supporting a cable used to manipulate roof trusses), an auger, a concrete bucket, and another type of implement. The telehandler 200 may permit a machine operator to control the tractive elements 212 and the implement 116 from within the cabin 208 to manipulate (e.g., move, carry, lift, transfer, etc.) a payload (e.g., pallets, building materials, earth, grain, etc.). In some embodiments, the implement may be powered by the engine. By way of example, the boom assembly 224 may include a lift actuator that raises and lowers the boom assembly 224, an extension actuator that extends and retracts the boom assembly 224, and an implement actuator that rotates the implement 116 relative to the boom assembly 224. Each of these actuators may be hydraulic actuators that are powered by a pump driven by the engine 112.

The telehandler 200 includes the battery 104 structured to supply power to the starter motor 108 (e.g., gear-reduction, direct-drive, solenoid-operated, etc.) that is configured to turn over, crank, start, or activate the engine 112, and the ignition interface 110 (e.g., key, button, mobile application, biometric authorization, etc.) coupled to activate the battery 104 and the starter motor 108. The sensor array 148 (e.g., including a crankshaft position sensor) measures speeds of the engine 112 during ignition, activation, or starting of the engine 112.

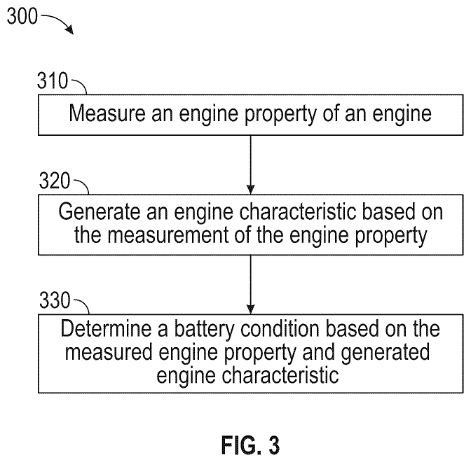

FIG. 3 shows a flow chart of a method 300 for operating the engine ignition flag system 100 of FIG. 1 according to an exemplary embodiment. In the method 300, the sensor array 148 measures operating characteristics of the engine 112 and the processing circuit 128 determines the condition of the battery 104. A notification is then provided to a user indicating the condition of the battery 104 and whether the battery 104 requires maintenance or replacement.

The method 300 begins at operation 310 with measuring an engine property of the engine 112. The sensor array 148 may measure one or more engine properties (e.g., positions or conditions of engine components, such as an engine block, cylinders, pistons, crankshaft, valves, camshaft, pump, injectors, exhaust, etc. The measured engine properties may include engine speed, torque, power output, fuel consumption, coolant temperature, oil pressure, exhaust gas temperature, air-fuel ratio, engine knock, boost pressure, crankshaft position, and exhaust emissions. To sense the engine 112, the sensor array 148 may include a position sensor, tachometer, dynamometers, flowmeter, pressure sensor, etc. In some embodiments, a position sensor senses the position and rotational speed of a crankshaft to measure an engine speed (e.g., a rotational speed) of the engine 112.

At operation 320, an engine characteristic based on the measurement of the engine property is generated. The generating of the engine characteristic may include calculations, assessments, and/or determinations. In some embodiments, the characteristic of the measurement of engine speeds may include estimated parameters of the engine 112 (e.g., engine speed, torque, power output, fuel consumption, coolant temperature, oil pressure, exhaust gas temperature, air-fuel ratio, engine knock, boost pressure, crankshaft position, exhaust emissions, ignition duration, etc.), calculated parameters of the engine 112 (e.g., horsepower, fuel efficiency, throttle, engine load, engine acceleration, compression ratio, thermal efficiency, ignition timing, etc.), and/or qualitative assessments of the measurement (e.g., whether an engine speed reached a threshold, whether an engine speed fluctuates, etc.). In some embodiments, the processing circuit 128 calculates the engine acceleration (e.g., a rate of change of engine speed) based on the measured engine speeds. In some embodiments, the processing circuit 128 determines whether the engine speed has reached or exceeded a threshold engine speed.

At operation 330, a battery condition based on the measured engine property and generated engine characteristic is determined. The determination of the battery condition may include user-defined classifications or evaluations of the overall state of a battery's performance, efficiency, and the ability of the battery 104 to hold and deliver charge. In some embodiments, the battery condition may include a qualitative classification (e.g., ‘healthy,’ ‘warning,’ ‘failing,’ etc.) or a quantitative evaluation (e.g. ‘100%,’ ‘6 of 10,’ etc.). In some embodiments, the processing circuit 128 determines that the battery 104 is ‘healthy’ if the engine acceleration is substantially constant. In some embodiments, the processing circuit 128 determines that the battery 104 is in a ‘warning’ state if the engine speed reaches a threshold but struggles to do so. By way of example, the engine speed may reach the threshold, but the engine acceleration may be below a threshold engine acceleration. By way of another example, the engine speed may reach the threshold, but the engine acceleration may decrease throughout the measurement period. In some embodiments, a processing circuit 128 determines that the battery 104 is ‘failing’ if the engine speed does not reach the threshold at all.

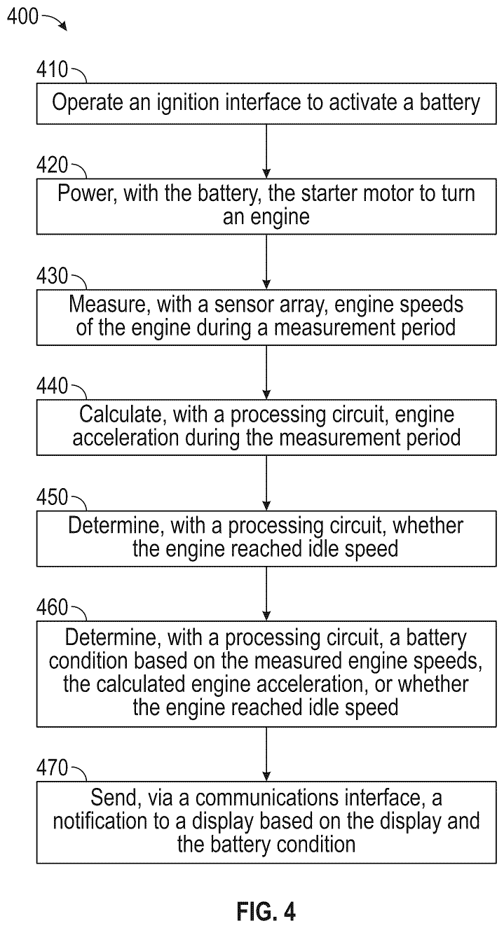

FIG. 4 is a flow chart of a method 400 for operating the engine ignition flag system 100, according to an exemplary embodiment. The method 400 begins at operation 410 with a machine operator operating the ignition interface 110 to activate the battery 104 of the work machine 102 (e.g., insert and turn a key, press button, etc.). At operation 420, the battery 104 powers the starter motor 108 and the starter motor 108 activates the engine 112 by turning an engine component, such as a crankshaft (e.g., turns over or cranks the engine 112). To maintain the rotation of the engine 112, the battery 104 continues to supply electrical energy (e.g., at a constant voltage) to the starter motor 108 until an idle speed is reached. The idle speed is a minimum engine speed or threshold speed at which the engine 112 is capable of running without the use of the starter motor 108. Once the engine speed is at the idle speed, the engine 112 is self-sustaining, and the battery 104 and starter motor 108 are deactivated. In some embodiments, a processing circuit 128 deactivates the battery 104 and the starter motor 108 once the engine speed reaches the idle speed. Factors that affect the idle speed include engine temperature, battery voltage and the type of electrical system, fuel delivery and air intake system, idle air control valve and throttle body status, sensor condition and control module settings, vacuum leaks, engine compression and health, fuel quality, exhaust system and component condition, engine load, and engine modifications. In some embodiments, the idle speed is a user-defined value an automatically calculated value based on the aforementioned factors.

At operation 430, the sensor array 148 measures the engine speeds of the engine 112 for a measurement period. Measuring the engine speed may include a position sensor detecting the position of a crankshaft of the engine 112. The measurement period may begin at the same time or substantially the same time as when the ignition interface 110 activated the battery 104, the time when the battery 104 began to power the starter motor 108, or the time when the starter motor 108 began to turn over the engine 112. In some embodiments, the measurement period is based on the time to reach the idle speed (TRIS). In some embodiments, the measurement period is substantially the same duration or longer than the TRIS. Factors that affect TRIS include engine temperature, ambient temperature, engine design, idle control system, fuel and air system condition, battery and charging system condition, engine load, vacuum leaks, engine health, fuel quality, and engine programming. In some embodiments, the measurement period is a user-defined value or an automatically calculated value based on the aforementioned factors.

At operation 440, a processing circuit 128 calculates the engine acceleration of the engine 112 during the measurement period. In some embodiments, the calculation of the engine acceleration includes a processing circuit 128 calculating a mathematical derivation (i.e., a derivative) of the measured engine speeds. At operation 450, a processing circuit 128 determines whether the engine reached a threshold speed such as the idle speed. In some embodiments, the processing circuit 128 conducts a Boolean evaluation between the idle speed and the engine speed at the end of the measurement period. In some embodiments, the processing circuit 128 conducts Boolean evaluations between the idle speed and multiple time points in the measurement period.

At operation 460, the processing circuit 128 determines a battery condition based on the measured engine speeds, the calculated engine acceleration, and/or the whether the engine speed reached the idle speed. In some embodiments, the processing circuit 128 determines a battery condition of ‘healthy’ if the engine acceleration is constant and the engine speed reached the idle speed, a battery condition of ‘warning’ if the engine acceleration is not constant and the engine speed reached the idle speed, or a battery condition of ‘failing’ if the engine speed did not reach the idle speed.

At operation 470, the communications interface 144 sends a notification to a display (e.g., the user interface 152, the remote display device 168, the local display device 160, etc.) based on the display and the determined battery condition. A display may include a display screen, a lamp or light, an audio device, a dial, another display, an output device, or a combination thereof. In some embodiments, if a display is a light, a notification based on a ‘healthy’ battery condition may not turn on the light, a notification based on a ‘warning’ battery condition may turn on the light at a medium brightness, and a notification based on a ‘failing’ battery condition may turn on the light at maximum brightness. In some embodiments, if a display is a display device, a notification based on a ‘healthy’ battery condition may project a “healthy” text, a notification based on a ‘warning’ battery condition may project a “warning” text, and a notification based on a ‘failing’ battery condition may project a “failing” text. In some embodiments, notifications based on quantitative evaluations (e.g., 0%, 20%, 6 of 10, etc.) may activate a display in a stepwise manner. In some embodiments, the display is the user display 156 integrated or attached to the work machine 102, the local display device 160 located on the jobsite, or the remote display device 168 located off the jobsite.

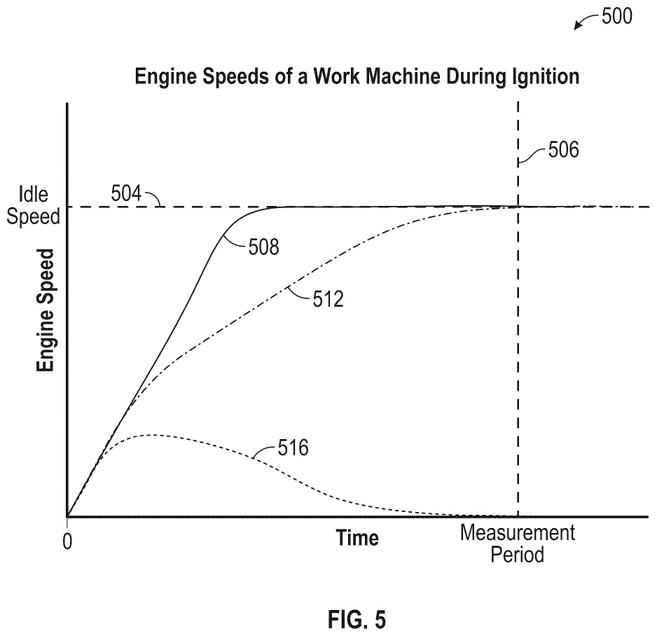

FIG. 5 shows a graph 500 of engine speeds of the work machine 102 of FIG. 1 during ignition according to some embodiments. Describing the graph, time is represented along the x-axis and the engine speed is represented along the y-axis. The idle speed is represented by line 504. In some embodiments, the measurement period and the idle speed are measured in seconds (s). In some embodiments, the measurement period ranges from thirty seconds to three minutes. The measurement period is represented by line 506. In some embodiments, the engine speed and the idle speed are measured in revolutions per minute (RPM). In some embodiments, the idle speed ranges from 500-2000 RPM. The graph begins at a time ‘0’. In some embodiments, the time ‘0’ indicates the beginning of the measurement period. The graph begins at an engine speed of zero. In some embodiments, the engine speed of zero indicates the engine speed before ignition (e.g., when stopped).

Graph 500 shows three measurements of engine speeds. A first measurement 508 shows an engine speed that increases with a constant slope from time ‘0’ until it reaches the idle speed (line 504) and maintains at the idle speed after the measurement period (line 506). A second measurement 512 shows an engine speed that initially increases with the same slope as the first measurement 508, then increases at a lesser slope, and finally maintains at the idle speed after the measurement period. A third measurement 516 initially increases with the same slope as the first measurement 508 and the second measurement 512, then increases at a lesser slope, and finally decreases to an engine speed of zero.

To generate an engine characteristic based on a graph of an engine property such as the graph 500, a processing circuit 128 may perform a mathematical analysis of the measured sensor data. In some embodiments, the processing circuit 128 differentiates a measurement of the engine speed to calculate an engine acceleration (i.e., a rate of change of the engine speed). The calculated engine acceleration may be indicative of the health of the battery 104. The starter motor 108 may be capable of sustaining a certain engine acceleration for a given voltage supplied by the battery 104. Both a healthy battery 104 and a failing battery 104 may initially be capable of supplying the target voltage necessary for a desired engine acceleration. However, as the health of the battery 104 begins to decline, the battery 104 may be capable of sustaining the target voltage for a shorter period of time. Accordingly, the engine accelerations for a healthy battery and a failing battery may be substantially equal to one another initially, but the engine acceleration of a failing battery may start to decline as the voltage supplied by the battery 104 decreases.

By way of example, the first measurement 508 has a substantially constant engine acceleration from time ‘0’ to the time when the first measurement 508 reaches the idle speed. Because the battery 104 is capable of supplying the target voltage until the engine speed reaches the idle speed, the first measurement 508 may represent a healthy battery condition. The control module 124 may determine based on the first measurement 508 that the battery 104 has a ‘healthy’ condition. The engine ignition flag system 100 may accordingly provide a notification indicating to a user that the battery 104 is healthy in response to receiving the first measurement 508.

The second measurement 512 has an engine acceleration that is initially equal to the engine acceleration of the first measurement 508 and then decreases before the second measurement 512 reaches the idle speed. Although the battery 104 is capable of reaching the idle speed, the engine acceleration does decrease, indicating a poorer health condition than that of the first measurement 508. The control module 124 may determine based on the second measurement 512 that the battery 104 has a ‘warning’ battery condition. In some embodiments, the control module 124 determines that the battery has the ‘warning’ battery condition in response to the engine acceleration decreasing instead of remaining constant. In some embodiments, the control module 124 determines that the battery has the ‘warning’ battery condition in response to the engine acceleration falling below a threshold engine acceleration. In some embodiments, the control module 124 determines that the battery has the ‘warning’ battery condition in response to the engine speed reaching the threshold speed after a threshold time (e.g., idle speed is reached but more slowly than the measurement 508). The engine ignition flag system 100 may accordingly provide a notification indicating to a user that the health of the battery 104 is decreasing in response to receiving the second measurement 512. The notification may include an instruction to check, monitor, or replace the battery 104.

The third measurement 516 has an engine acceleration that is initially equal to the engine acceleration of the first measurement 508 and the second measurement 512, and then begins to decrease. The third measurement 516 fails to reach the idle speed within the measurement period and eventually reaches an engine speed of 0. The control module 124 may determine based on the third measurement 516 that the battery 104 has a ‘failing’ battery condition. The engine ignition flag system 100 may accordingly provide a notification indicating to a user that the battery 104 has failed or is failing in response to receiving the third measurement 516. The notification may include an instruction to check, monitor, or replace the battery 104.

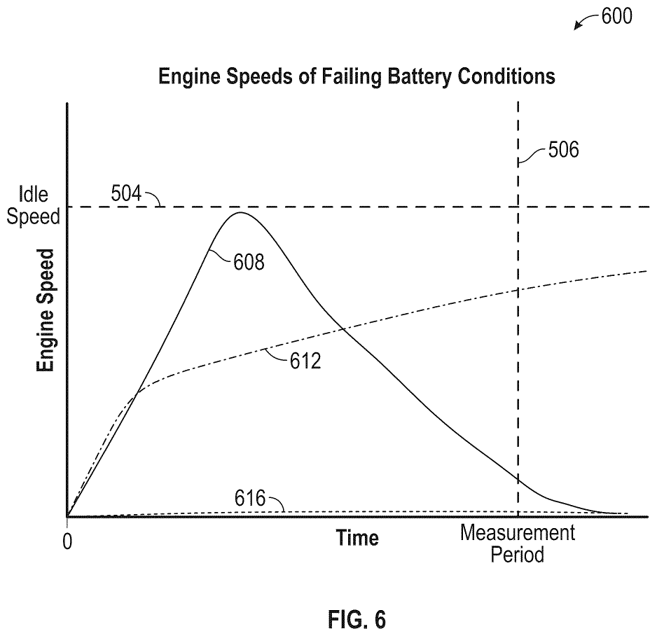

FIG. 6 shows a graph of engine speeds of the work machine of FIG. 1 associated with failing battery conditions. Graph 600 shows three measurements of engine speeds associated with failing battery conditions. A fourth measurement 608 shows an engine speed that increases with a constant engine acceleration from time ‘0’ and then decreases in engine acceleration before reaching an engine speed of zero. A fifth measurement 612 shows an engine speed that initially increases with the same engine acceleration as fourth measurement 608, then increases at a lesser slope, and not reaching the idle speed (line 504) during the measurement period (line 506). A sixth measurement 616 increases with a small engine acceleration and only reaching and maintaining an engine speed slightly above zero.

By way of example, the fourth measurement 608 has a substantially constant engine acceleration from time ‘0’ to a time when the fourth measurement 608 reaches a peak speed below the idle speed before decreasing. The fourth measurement 608 fails to reach the idle speed within the measurement period and eventually reaches an engine speed of 0. The control module 124 may determine based on the fourth measurement 608 that the battery 104 has a ‘failing’ battery condition. The engine ignition flag system 100 may accordingly provide a notification indicating to a user that the battery 104 has failed or is failing in response to receiving the fourth measurement 608. The notification may include an instruction to check, monitor, or replace the battery 104.

The fifth measurement 612 has an engine acceleration that is initially equal to the engine acceleration of the fourth measurement 608 and then decreases before the fifth measurement 612 fails to reach the idle speed within the measurement period. Although the fifth measurement 612 continues to increase in speed, the fifth measurement 612 fails to reach the idle speed within the measurement period. The control module 124 may determine based on the fifth measurement 612 that the battery 104 has a ‘failing’ battery condition. The engine ignition flag system 100 may accordingly provide a notification indicating to a user that the battery 104 has failed or is failing in response to receiving the fifth measurement 612. The notification may include an instruction to check, monitor, or replace the battery 104.

The sixth measurement 616 has an engine acceleration that is substantially less than the fourth measurement 608 and the fifth measurement 612 before maintaining a constant low speed. The sixth measurement 616 fails to reach the idle speed within the measurement period and maintains a low speed. The control module 124 may determine based on the sixth measurement 616 that the battery 104 has a ‘failing’ battery condition. The engine ignition flag system 100 may accordingly provide a notification indicating to a user that the battery 104 has failed or is failing in response to receiving the sixth measurement 616. The notification may include an instruction to check, monitor, or replace the battery 104.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other some embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any processor, controller, microcontroller, or state machine. A processor also may be implemented as a combination of computing devices, such as a combination of a DSP and a microprocessor, a series of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor by a processing circuit and includes computer code for executing (e.g., by a processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the engine ignition flag system 100 as shown in the various some embodiments are illustrative only. Additionally, any element disclosed in one embodiment may be incorporated or utilized with any other embodiment disclosed herein. For example, the engine ignition flag system 100 of the exemplary embodiment shown in at least FIG. 1 may be incorporated in the telehandler 200 of the exemplary embodiment shown in at least FIG. 2. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An engine ignition flag system, comprising:
an engine;
a starter motor coupled to start the engine;
a battery configured to power the starter motor;
a sensor coupled to the engine and configured to provide sensor data indicating a speed of the engine;
a user interface; and
a controller operatively coupled to the sensor and configured to:
receive, from the sensor, the sensor data corresponding to a measurement period;
determine, based the speed of the engine during the measurement period, a condition of the battery; and
control the user interface to provide a notification indicating the condition of the battery.

2. The engine ignition flag system of claim 1, wherein the controller is configured to determine the condition of the battery based on whether the speed of the engine reaches a threshold speed during the measurement period.

3. The engine ignition flag system of claim 2, wherein the controller is further configured to determine the condition of the battery when the speed of the engine does not reach the threshold speed.

4. The engine ignition flag system of claim 2, wherein the controller is further configured to determine the condition of the battery when the speed of the engine reaches the threshold speed at a substantially constant rate of change of the speed of the engine.

5. The engine ignition flag system of claim 2, wherein the controller is further configured to determine the condition of the battery when the speed of the engine reaches the threshold speed at a rate of change of the speed of the engine that is lower than a threshold rate of change.

6. The engine ignition flag system of claim 1, wherein the controller is further configured to calculate a rate of change of the speed of the engine.

7. The engine ignition flag system of claim 1, wherein the sensor comprises a crankshaft position sensor configured to detect a rotational speed of a crankshaft of the engine.

8. A method of determining a battery condition, comprising:
controlling a battery to operate a starter motor to start an engine;
measuring, using a sensor, an engine property of the engine while the starter motor is operated; and
determining, based on the engine property, a condition of the battery.

9. The method of claim 8, wherein measuring the engine property comprises measuring an engine speed using a position sensor configured to sense rotational position of a crankshaft.

10. The method of claim 9, wherein determining the condition of the battery comprises calculating a rate of change of the engine speed.

11. The method of claim 8, further comprising generating an engine characteristic based on measuring the engine property, wherein generating the engine characteristic comprises calculating or estimating a value from the engine property.

12. The method of claim 11, wherein determining the condition of the battery comprises selecting the battery condition from a plurality of classifications of the engine property and generated engine characteristic.

13. The method of claim 8, further comprising determining an idle speed of the engine, wherein the idle speed is a minimum engine speed at which the engine is capable of running without the starter motor turning the engine.

14. The method of claim 13, further comprising determining a measurement period based on a time for the engine to reach the idle speed.

15. A method of displaying a battery condition, comprising:
powering, by a battery, a starter motor to turn an engine;
measuring, with a sensor, an engine speed of the engine for a measurement period;
determining the battery condition of the battery by:
calculating a rate of change of the engine speed during the measurement period based on the engine speed; and
determining whether the engine speed reached a threshold speed during the measurement period; and
providing a notification to a display indicating the battery condition.

16. The method of claim 15, further comprising determining whether the rate of the change of the engine speed is substantially constant.

17. The method of claim 15, wherein measuring the engine speed of the engine comprises detecting a rotational speed of a crankshaft of the engine.

18. The method of claim 15, further comprising determining the threshold speed based on an idle speed of the engine, wherein the idle speed is a minimum engine speed at which the engine is capable of running without the starter motor turning the engine.

19. The method of claim 18, further comprising determining the measurement period based on a time for the engine to reach the idle speed.

20. The method of claim 15, further comprising determining the battery condition from a plurality of classifications of the engine speed and the rate of change of the engine speed.
